(19) United States
(12) Patent Application Publication
(10) Pub. No.: US 2006/0278336 A1
(43) Pub. Date: Dec. 14, 2006

(54) Method and apparatus for the treatment of wood or wood products

(75) Inventors: Goran Sundholm, Tuusula (FI); Ari Hottinen, Pajujarvi (FI)

Correspondence Address: LADAS & PARRY, 26 WEST 61ST STREET, NEW YORK, NY, 10023, US

(73) Assignee: TEKNOCOMP OY

(21) Appl. No.: 11/438,136

(22) Filed: May 19, 2006

Related U.S. Application Data
(63) Continuation-in-part of application No. PCT/FI04/00696, filed on Nov. 18, 2004.

(30) Foreign Application Priority Data
Nov. 21, 2003 (FI) 20031697
Oct. 1, 2004 (FI) 20041278

(51) Int. Cl. C09J 5/00

(52) U.S. Cl. 156/312; 156/307.3; 100/92

(57) ABSTRACT

A method for the treatment of wood or wood products, in which method moist wood or wood products (1) are dried by first pressing and further by heating so that a desired degree of dryness is reached. In a first stage, the wood or wood products (1) arranged between treating elements (2) are pressed between the treating elements (2) so that a considerable amount of water is removed from the wood being treated, next the treating elements (2) are locked so that the wood or wood products (1) remain compressed between the treating elements (2), and the combination of treating elements (2) and wood or wood products (1) between them thus formed is moved into a drying chamber (D), where the wood or wood products are dried further by applying heat. The invention also relates to an apparatus.

### BACKGROUND OF THE INVENTION

The present invention relates to a method as defined in the preamble of claim 1 for the treatment of wood or wood products, in which method moist wood or wood products are dried by first pressing and further by heating so as to achieve a desired degree of dryness.

The present invention relates to a method as defined in the preamble of claim 2 for the treatment of wood or wood products, in which method moist wood or wood products are dried by first pressing and further by heating so as to achieve a desired degree of dryness.

The invention also relates to a method as defined in claim 8 for the manufacture of a wood product board, especially a sandwich board, such as plywood board.

The invention also relates to an apparatus for the treatment of wood or wood products as defined in the preamble of claim 15, said apparatus comprising a press by means of which moist wood is first dried by pressing, means for heating the wood or wood products so as to achieve a desired degree of dryness.

The invention also relates to an apparatus as defined in claim 23 for the manufacture of a wood product board, especially a sandwich board, such as plywood board.

Methods for the treatment of wood and wood products, especially timber, are known in which wood is dried by pressing and simultaneously heating the wood. Press drying is typically performed using a press arranged in a drying chamber. A method of this type is disclosed in specification WO 94/26485. Other press drying arrangements are also known, e.g. from specification FI 97961B. A feature common to all these is typically that the pressing and the heat drying of the timber are performed in the same chamber. Therefore, the pressing equipment used is required to have a considerable thermal resistance, especially because during the drying phase the temperatures may rise to a fairly high level, i.e. considerably over the boiling point of water. On the other hand, the amount of energy required during the drying phase is high when large quantities of wood are to be dried at a time. Correspondingly, this requires high-power pressing equipment when large quantities of wood are to be treated at a time.

In the manufacture of plywood board, the veneers used to produce plywood board are typically dried in a separate drying apparatus and after the drying treatment a separate pressing treatment is applied in which the dried veneers are placed one upon the other with a binding agent between the veneers, whereupon they are pressed to produce a plywood board. This solution requires the use of several different apparatuses.

The object of the present invention is to create a completely new type of solution for press drying of wood and wood products that makes it possible to avoid certain drawbacks of prior art. A further object of the invention is to achieve a solution in which the amount of energy needed in the drying is reduced as far as possible. Yet another object of the invention is to create an efficient and flexible solution for the drying of timber. The object of the invention is to create a solution for the manufacture of wood product boards, such as plywood boards, and for the drying of the veneers used in the manufacture.

### BRIEF DESCRIPTION OF THE INVENTION

The method of the invention as defined in claim 1 is mainly characterized in that, in a first stage, the wood or wood products arranged between treating elements are pressed between the treating elements so that a considerable amount of water is removed from the wood being treated, next the compression pressure between treating elements and wood or wood products is relieved so that compression of the wood or wood products is relieved and after that the compression pressure is increased so that compression of the wood or wood products is increased and the wood or wood products remain compressed between the treating elements and the wood or wood products are dried further by applying heat.

The method of the invention as defined in claim 2 is mainly characterized in that, in a first stage, wood or wood products arranged between treating elements are pressed between the treating elements so that a considerable amount of water is removed from the wood being treated, next the treating elements are locked so that the wood or wood products remain compressed between the treating elements, and the combination of treating elements and wood or wood products between them thus formed is moved into a drying chamber, where the wood or wood products are dried further by applying heat.

The method of the invention is additionally characterized by what is stated in claims 3-8.

The method of the invention as defined in claim 9 is mainly characterized in that wood products used in the method consist of fresh veneer sheets, a desired number of which are placed one upon the other between the treating elements, and a binding agent, such as glue, is applied to all the sheets placed one upon the other, the board blank formed by the veneers and binding agent is first dried in a first stage at a first temperature T1 and/or under a first compression pressure P1, the temperature is raised to a second temperature T2 and the compression pressure is increased to a second compression pressure P2.

The method of the invention is additionally characterized by what is stated in claims 9-14.

The apparatus of the invention as defined in claim 16 is characterized in that the apparatus comprises a pressing chamber and a drying chamber, which are separate from each other, and treating means between which the wood or wood product can be arranged, which treating means can be locked in a pressing position, in which condition the combination of the treating means and the timber between them can be moved from the pressing chamber into the drying chamber and from there to a further processing stage.

The apparatus of the invention is additionally characterized by what is stated in claims 17-23.

The apparatus of the invention as defined in claim 24 is characterized in that the apparatus comprises a pressing chamber containing pressing means, a drying chamber, and treating means forming spaces between them where sandwich board blanks consisting of fresh superimposed veneer sheets and binding agent can be arranged, which treating means can be locked in a pressing position, and that the combination of the treating means and the sandwich board blanks in the spaces between them can be moved from the pressing chamber into the drying chamber and/or to a further processing stage.

The apparatus of the invention is further characterized by what is stated in claims 25-26.

The solution of the invention has numerous significant advantages. Removing some of the water from the wood by pressing is more economical than drying by only heating. The vaporisation of the water requires more energy than the pressing. The pressing can be implemented in a desired manner, by using an even and constant pressure or also e.g. by varying the compression pressure, causing the moisture to be equalised in the wood material being treated. In the actual drying stage, when the temperature rises over the boiling point of water, a considerable portion of the moisture has already been removed from the wood material being treated, and thus a considerably smaller amount of heat is required for boiling the water remaining in the wood material. Several drying and cooling chambers can be provided for one press. The amount of wood material to be treated in a single operation can thus be smaller in order to achieve the same capacity than by using only one drying chamber. The structures of the pressing equipment used in the pressing stage can be designed to correspondingly smaller dimensions. In addition, as the pressing chamber and the drying chamber are separate from each other, it is possible to maintain different conditions in them, thus saving time and energy as compared with a solution where the pressing and the drying are performed in the same space. The drying chamber can be made small because the requirements of the press need not be taken into account and in addition the fans used in the drying chamber can be disposed optimally. By using at least two fans arranged on opposite sides of the drying chamber and directing the air flow in such way that the air flow produced by one fan is passed to the suction side of another fan, a very effective air circulation is achieved in the drying chamber. This further improves the efficiency of the drying stage. Recovery of heat at different stages of the method further reduces the amount of energy needed. The use of lockable treating means makes it possible to achieve a solution in which the wood material to be treated can be held under compression during the drying stage as well. By using the method and apparatus of the invention in the manufacture of plywood boards, it is possible to combine the previously separate drying stage, in which the veneer sheets are dried, and the gluing/pressing stage for producing the actual board. The method and apparatus of the invention thus make it possible to achieve significant savings on the equipment and overall process required in the manufacture of plywood boards. Using heat recovery and heat circulation, the apparatus enables energy savings.

### BRIEF DESCRIPTION OF THE FIGURES

In the following, the invention will be described in detail with reference to an example and the attached drawings, wherein

FIG. 1 presents a diagram representing an apparatus according to the invention,

FIG. 2 presents a simplified view of an embodiment of the pressing chamber of the invention, sectioned along line II-II in FIG. 1,

FIG. 3 presents a part of the apparatus of the invention sectioned along line III-III in FIG. 1,

FIG. 4 presents an embodiment of the drying chamber of the invention sectioned along line IV-IV in FIG. 1,

FIG. 5 presents an embodiment of the cooling chamber of the invention sectioned along line V-V in FIG. 1,

FIG. 6 represents a second embodiment of the invention, and

FIG. 7 represents the solution of the invention in the production of plywood.

### DETAILED DESCRIPTION OF THE INVENTION

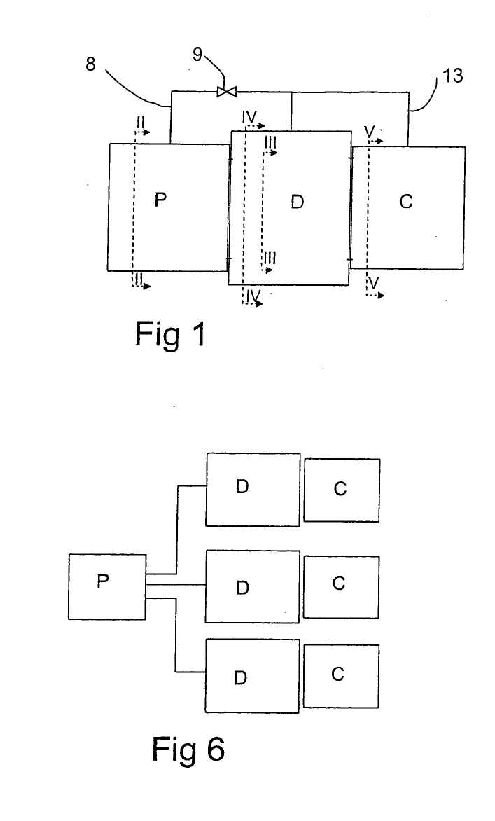

FIG. 1 presents a diagrammatic illustration of an embodiment of the invention. It comprises a pressing chamber P, a drying chamber D and after these a cooling chamber C, arranged one after the other.

In the method of the invention, the wood or wood products, such as timber 1, are first brought to an assembly station (not shown in the figures). At the assembly station, the timber 1 is set (typically generally automatically) in the spaces between the treating elements 2, such as heating plates. The timber thus set forms a batch.

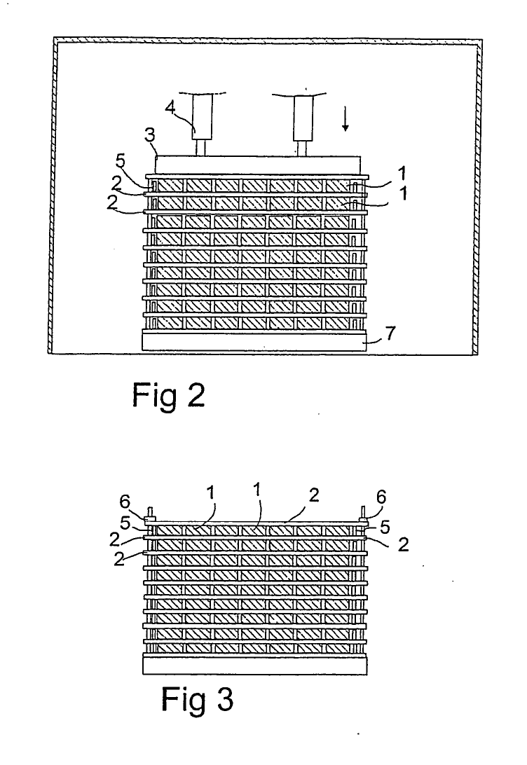

The batch is fed into the pressing chamber P. FIG. 2 shows a simplified view of a pressing chamber P used in the method of the invention. The combination consisting of the superimposed treating elements 2 and the timber 1 arranged between them is in the pressing chamber P, where the combination is pressed by means of pressing elements 3, 4 so that the timber 1 is compressed between the treating elements 2. The straining beam 3 of the pressing elements 3, 4 is moved typically by means of at least one cylinder-piston combination 4. In the case illustrated in the figure, a pressure is applied by the pressing elements 3, 4 to the upper surface of the topmost treating element 2, the timber between the treating elements being thus compressed. The bottommost one of the treating elements 2 may be placed e.g. on a base 7 substantially immovable in the pressing direction.

In an embodiment of the invention in a first stage, i.e. pressing stage, the wood or wood products 1 arranged between treating elements 2 are pressed between the treating elements 2 so that a considerable amount of water is removed from the wood being treated, next the compression pressure between treating elements 2 and wood or wood products is varied so that compression of the wood or wood products is relieved and after that the compression pressure is varied so that compression of the wood or wood products is increased. This can be repeated several times. Next, the wood or wood products 1 remain compressed between the treating elements 2 and the wood or wood products are dried further, in a drying phase by applying heat. The pressing can be implemented in a desired manner by varying the compression pressure, causing the moisture to be equalised in the wood material being treated. In the pressing stage the wood material can be preheated. The temperature can be in the first stage typically under about 80° C., preferably 0-65° C. In the second stage the temperature can be 100-140° C. Typical holding times can be 8-10 hours in the first phase and 8-10 hours in the second phase. The temperatures and holding times in the first and second phases are depending on the properties of the wood being treated.

In the pressing chamber P, the combination of timber 1 and treating elements 2 is compressed until the elements reach thickness defining stoppers 5 provided in the pressing spaces, so that a desired compression of the wood or wood products is reached and free water is pressed out of the wood. The amount of water thus removed may be as much as 50% of the water content. The amount of water removed by pressing is typically about 20-50% of the water content. The compression pressure used depends on the kind of wood being treated and the thickness of the timber, being typically 5-20 kp/cm².

During the pressing stage, the wood may also be heated, in which case, depending on the properties of the wood species being treated, the wood material is softened and the water is removed more readily. During the pressing stage, the aim is to keep the treatment temperature below the boiling point of water. The temperature can be increased during the pressing stage, e.g. by 40-80° C. As the wood is softened, the pressing becomes easier and a lower compression pressure can be used if desired.

By keeping the temperature below the boiling point of water, heating energy is saved. It is to be noted that the wood material being treated is also heated as a consequence of the compression. The rise of temperature as a consequence of compression varies, depending on the wood species or wood quality etc. In some wood species a considerable rise of temperature occurs as a result of the pressing, and therefore no additional heat may be needed at all or only very little additional heat may be needed during the pressing stage.

The pressing can be implemented in a desired manner, by using an even and constant pressure or also e.g. by varying the compression pressure, causing the moisture to be equalised in the wood material being treated. Typically the wood material to be treated reaches a moisture content of 16-20% after the pressing stage. During the pressing, the water is removed through apertures (not shown) formed in the treating elements, such as heating plates. The apertures may be of different sizes and shapes and their number may vary depending on the embodiment. In one embodiment, the treating elements 2 are provided with channels, e.g. for conveying a heating medium through them. The heating medium may be e.g. warm air and/or water vapour obtained from the drying stage.

FIG. 1 shows diagrammatically a passage 8 for a heating medium from the drying chamber D to the pressing chamber P. The passage is provided with a valve element 9, which can be controlled e.g. by a control system (not shown) or in some other way.

In another embodiment, the treating elements comprise channels formed to allow circulation of a heating medium, especially a heating fluid, such as oil.

The combination of treating elements 2 and wood or wood products is locked so that the wood or wood products placed in the pressing spaces remain under compression between the treating elements 2. In the locked position, the treating elements 2 are typically moved against the thickness defining stoppers 5. FIG. 3 shows a diagrammatic representation of a combination of treating elements and timber as applied in a method according to the invention, in the locked position. The treating elements are locked by means of locking elements 6 in place, allowing the combination of treating elements and timber to be moved into the drying chamber D. The locking means 6 are typically mechanical locking means.

The heat that may be used at the drying stage is mainly obtained from the waste heat, mainly steam, produced in the drying chamber D in the next stage. Between the pressing chamber P and the drying chamber D, a passage 8 is provided to transfer heat from the drying chamber into the pressing chamber. The passage is provided with a shutter element 9, such as a valve element, which can be opened and closed as necessary. The valve element is preferably a gravitational valve such that, when the steam pressure in the drying chamber D rises, the valve element 9 opens and the steam flows through the passage 8 into the pressing chamber. For the sake of clarity, FIG. 1 shows the passage depicted outside the chambers. In practice, the shortest route from the drying chamber to the pressing chamber is chosen for the passage.

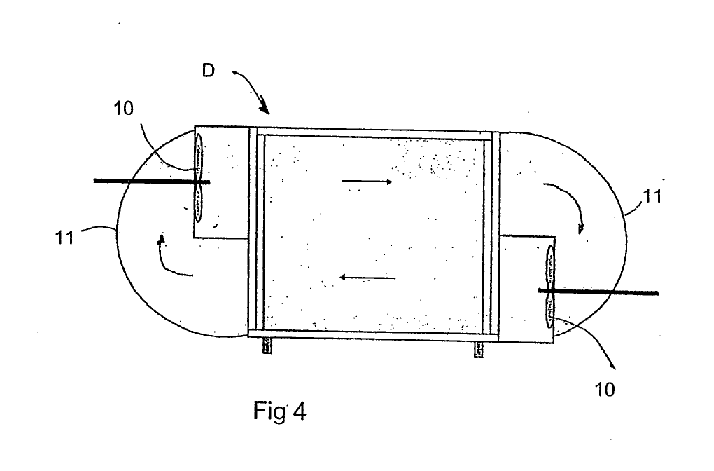

In the drying chamber D, the wood to be treated is heated over the boiling point of water so that the steam makes the chamber a substantially inert space, which means that the colour of the wood being treated is not changed. The wood is preferably heated to a temperature over 120° C. to ensure that the wood dies, i.e. that a structural change occurs and the treated wood material will not undergo deformations or cracking. The adjustment of temperature during the drying process is implemented according to a programme applicable for each wood material to be treated. The aim is to dry the wood material to be treated in the drying chamber to a moisture content of typically 8-10%. The drying chamber is provided with an arrangement for effective circulation of the medium. As illustrated in FIG. 4, the drying chamber D is provided with fans 10 disposed on opposite sides of the drying chamber and producing a flow that has been fitted to be directed to the suction side of the fan placed on the opposite side of the drying chamber. Thus, the flow produced by the fan 10 feeds the opposite fan, which enhances the air circulation and the drying stage as a whole. According to the figure, the air flow is controlled by a guiding wall 11, which has the effect of creating a very effective circulation of air flow in the drying chamber D. The drying chamber comprises heat exchanger elements (not shown) known in themselves for supplying heat to the drying chamber. If necessary, it is possible to spray water into the drying chamber to produce water vapour. In this case, an inert space is formed in the drying chamber, at least in the vicinity of the wood material being treated.

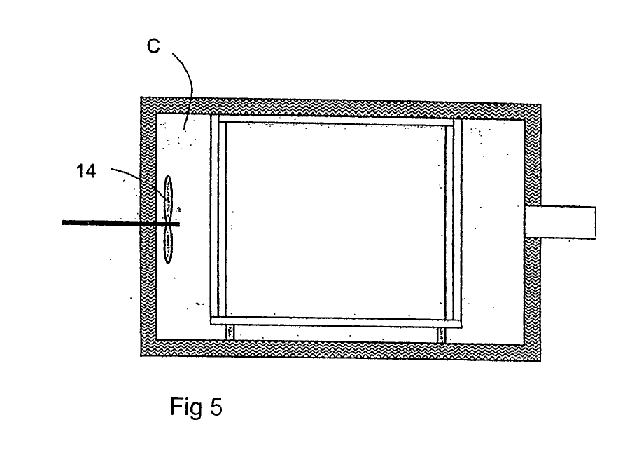

Once the desired drying result has been achieved, the batch is moved from the drying chamber D into the cooling chamber C. in the cooling chamber, the wood material is cooled slowly according to a given programme. FIG. 5 shows a simplified representation of a cooling chamber C. The cooling chamber is typically provided with at least one fan 14 or the like to set up a more effective air circulation. From the cooling chamber C, too, it is possible to recover heat for use e.g. for the heating of the pressing chamber. FIG. 1 shows diagrammatically a passage 13 that can be used as a heat transfer channel. Recovery of heat from different stages of the drying process reduces the energy requirement.

As shown in FIG. 6, several drying chambers D and cooling chambers C may be provided for one press P. in this case, the wood or wood products are transferred from the first stage in a selective manner to one of the several drying chambers D.

From the cooling chamber, the batch is moved to a discharge station (not shown). At the discharge station, the batch is discharged and the timber is stacked and packed for delivery.

The apparatus of the invention for the treatment of wood or wood products comprises a press by means of which the wood or wood products are first dried by pressing, and means for heating the wood or wood products so that a desired degree of dryness is reached. The apparatus comprises separate pressing means 3, 4, 7, a pressing chamber P, a drying chamber D and treating means 2 forming spaces between them where the wood or wood products 1 can be arranged, which treating means 2 can be locked in a pressing position, and that the combination of the treating means and the timber 1 between them can be moved from the pressing chamber P into the drying chamber D and then to a further processing stage. The treating means 2 can be locked with respect to each other by means of locking devices 6. The locking devices 6 are preferably mechanical locking devices.

According to a preferred embodiment, the apparatus further comprises means for conveying heat from the drying chamber D into the pressing chamber P when necessary. The means for conveying heat comprise a passage 8 provided with a shutter element 9, such as a valve element.

According to a second embodiment, the apparatus comprises a plurality of drying chambers D. In this case, the capacity of the press means and the pressing chamber P is preferably fitted to match the capacities of the several drying chambers D, i.e. to feed the several drying chambers.

The combination of treating means 2 and wood or wood products 1 is moved from one chamber to another by means of an actuator. The apparatus may comprise e.g. a carriage moving on rails and serving to move the combination of treating means and timber from one stage to the next.

The drying chamber D is provided with at least two fans 10 arranged on opposite sides of the chamber and that the air flow produced by the fan is directed from the fan to the suction side of the fan located on the opposite side of the chamber.

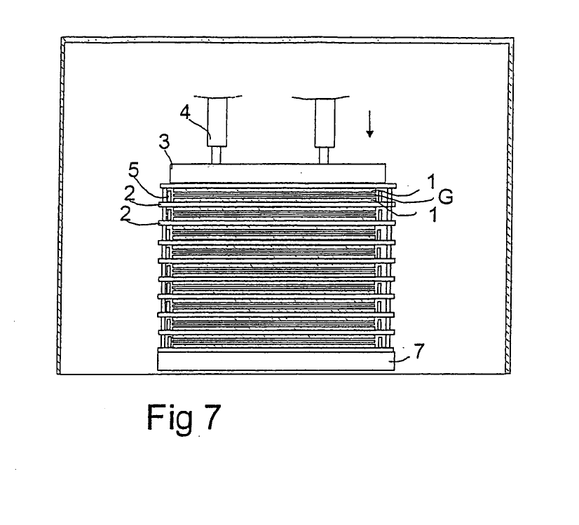

FIG. 7 presents an embodiment in which an apparatus according to claim is used in the manufacture of plywood. The figure presents a simplified view of a pressing chamber P used in the method of the invention. A combination consisting of treating elements 2 placed one above the other and wood material, i.e. veneer sheets 1 arranged in the spaces between them and binding agent G arranged between them is placed in the pressing chamber P, where the combination is pressed by means of pressing elements 3, 4 so that the board blank formed by a plurality of superimposed veneer sheets 1 is compressed between the treating elements 2. The pressing bar 3 of the pressing elements 3, 4 is moved typically by means of at least one cylinder-piston combination 4. In the case illustrated in the figure, the topmost treating element 2 is pressed by means of the pressing elements 3, 4 from its upper surface, causing the board blanks to be compressed in the spaces between the treating elements. The bottommost one of the treating means 2 may be arranged e.g. on a base 7 substantially immovable relative to the pressing direction.

In the pressing chamber P, the combination of veneer sheets 1, binding agent G and treating elements 2 is pressed with a first compression pressure P1 e.g. until reaching the stoppers 5 defining the height of the pressing spaces so that the desired compression of the sandwich board blank is achieved. The wood may also be heated during the pressing stage at a first temperature Ti, which has the result that, depending on the properties of the wood species being treated, the wood material is softened and the water is removed more readily. The treating temperature aimed at during the first stage is typically below or close to the boiling point of water, e.g. 95-105° C. The pressing may be performed in a desired manner, evenly with a constant pressure or also e.g. by varying the compression pressure, causing the moisture to be equalised in the wood material being treated. During the pressing, the water is removed through apertures (not shown) formed in the treating elements, such as heating plates. The apertures may be of different sizes and shapes and their number may vary depending on the embodiment. The treating means 2, which in one embodiment are provided with channels, e.g. for conveying a heating medium through them. The heating medium may consist of warm air and/or water vapour obtained from another stage, e.g. from the drying stage. In the embodiment in question, the wood products 1 used are fresh veneer sheets, a desired number of which are set one upon the other between the treating means 2, with a binding agent G, such as glue, applied to each superimposed sheet, and the board blank consisting of the veneer sheets 1 and the binding agent G is at first dried in a first stage at the first temperature T1 and/or under the first compression pressure P1, in a second stage the temperature is increased to a second temperature T2 and/or the compression pressure is increased to a second compression pressure P2. In the solution, the binding agent used is a thermally activated binding agent G, which is only activated e.g. at the second temperature T2. The first stage can be performed in the pressing chamber and/or in the drying chamber. The second stage can be most typically performed in the drying chamber, but in some embodiments other alternatives are also possible.

In an embodiment, the first temperature Ti is below 130° C., typically 95-105° C. Correspondingly, in the second stage of the embodiment, the second temperature T2 is 130 degrees or higher, typically 130-140° C. The length of time during which the board blank is held in the first stage, at the first temperature T1 and/or under the first compression pressure P1, is determined according to the degree of dryness of the veneer sheets. Once the veneer sheets of the board blank are sufficiently dry, the temperature is increased to the second temperature T2, e.g. to 130-140 degrees, and the compression pressure is increased to value P2 at the same time.

According to an embodiment, the first stage and the second stage are performed in the same apparatus, preferably also in the same space. On the other hand, it is also possible to apply solutions as illustrated in FIG. 1 and 6, in which the stages have been separated so that they are performed in different spaces.

In this case it is possible to apply the above-described features in the drying of timber or wood products.

### EXAMPLE

A number of fresh veneer sheets, e.g. 9 sheets, are set one upon the other and a binding agent, such as glue, is applied in each interspace. The binding agent has the property of being thermally activable, so that it is only activated e.g. at a temperature of 130-140° C. The veneer is at first dried at a temperature of 895-105° C. and under a low compression pressure. Once the veneer is sufficiently dry, the temperature is increased to 130-140 degrees and at the same time the compression pressure is increased. All this takes place during the same process, preferably also in the same space.

The method and apparatus of the invention can be used for the drying of timber, and if desired it can also be used for the production of compressed wood board. In addition, it can be used for the manufacture of sandwich boards, such as plywood boards. The drying of veneer sheets and the attaching of veneers superimposed in layers by using a binding agent or by pressing together to produce a plywood board are combined at the same time. ‘Fresh veneer sheet’ refers mainly to a moist veneer sheet that has not yet been specifically dried.

It is obvious to the person skilled in the art that the invention is not limited to the embodiments described above, but that it may be varied within the scope of the claims presented below. Features that may have been used together with other features in the description can also be used separately from each other if necessary.

1. A method for the treatment of wood or wood products, especially for the manufacture of sandwich boards, in which method moist wood or wood products (1) are dried by first pressing and further by heating so that a desired degree of dryness is reached, wherein in a first stage, i.e. in a pressing stage, the wood or wood products (1) arranged between treating elements (2) are pressed between the treating elements (2) so that a considerable amount of water is removed from the wood being treated, next the compression pressure between treating elements (2) and wood or wood products is varied so that compression of the wood or wood products is relieved and after that the compression pressure is varied so that compression of the wood or wood products is increased and the wood or wood products (1) remain compressed between the treating elements (2) and the wood or wood products are dried further in a drying phase by applying heat.

2. A method for the treatment of wood or wood products, especially for the manufacture of sandwich boards, in which method moist wood or wood products (1) are dried by first pressing and further by heating so that a desired degree of dryness is reached, wherein in a first stage, the wood or wood products (1) arranged between treating elements (2) are pressed between the treating elements (2) so that a considerable amount of water is removed from the wood being treated, next the treating elements (2) are locked so that the wood or wood products (1) remain compressed between the treating elements (2) and the combination of treating elements (2) and wood or wood products (1) between them thus formed is moved into a drying chamber (D), where the wood or wood products are dried further by applying heat.

3. A method according to claim 1, wherein in the first stage, i.e. in the pressing stage, the wood or wood products (1) being treated are heated, preferably to a temperature below the boiling point of water.

4. A method according to claim 1, wherein the wood or wood products in the drying phase, such as in the drying chamber (D), are heated to a temperature exceeding the boiling point of water.

5. A method according to claim 1, wherein heated medium, such as air and/or steam, is passed from the drying phase, such as the drying chamber (D), when necessary, to be utilised in the pressing stage.

6. A method according to claim 1, wherein the wood or wood products (1) being treated are transferred in a selective manner from the first stage into one of several drying chambers (D).

7. A method according to claim 1, wherein the combination of the wood or wood products (1) and the treating elements (2) is moved into a cooling chamber (C).

8. A method according to claim 1, wherein the combination of wood or wood products (1) and treating elements (2) is moved from the cooling chamber (C) to a discharge station, where the wood or wood products are released from the treating elements and removed to a further processing stage.

9. A method for producing a wood product board, especially a sandwich board, such as a plywood board, wherein the wood products (1) used in the method consist of fresh veneer sheets, a desired number of which are placed one upon the other between treating elements (2), and a binding agent, such as glue, is applied to all the sheets placed one upon the other, the board blank formed by the veneers and binding agent is first dried in a first stage at a first temperature (T1) and/or under a first compression pressure (P1), the temperature is raised to a second temperature (T2) and the compression pressure is increased to a second compression pressure (P2).

10. A method according to claim 9, wherein the binding agent used is a thermally activated binding agent, which is activated e.g. at the second temperature (T2).

11. A method according to claim 9, wherein the first temperature (T1) is lower than about 130° C., preferably 95-105° C.

12. A method according to claim 9, wherein the second temperature (T2) is higher than about 130° C., preferably 130-140° C.

13. A method according to claim 9, wherein the length of time during which the board blank is held in the first stage, at the first temperature (T1) and/or under the first compression pressure (P1), is determined according to the degree of dryness of the veneer sheets.

14. A method according to claim 9, wherein the first stage and the second stage are performed in the same apparatus, preferably also in the same space.

15. A method according to claim 9, wherein, during the first stage, moisture is increased if necessary, e.g. to equalise variations in the dryness of the veneer sheets.

16. An apparatus for the treatment of wood or wood products, said apparatus comprising a press by means of which moist wood is first dried by pressing, means for heating the wood or wood products so as to achieve a desired degree of dryness, wherein the apparatus comprises a pressing chamber (P) containing separate pressing means, a drying chamber (D) and treating means (2) forming spaces between them where the wood or wood products (1) can be arranged, which treating means can be locked in a pressing position, and that the combination of the treating means and the timber (1) between them can be moved from the pressing chamber into the drying chamber and from there to a further processing stage.

17. An apparatus according to claim 16, wherein apparatus further comprises means for conveying heat from the drying chamber (D) into the pressing chamber (P) when necessary.

18. An apparatus according to claim 17, wherein the means for conveying heat comprise a passage (8) provided with a shutter element (9), such as a valve element.

19. An apparatus according to claim 16, wherein the apparatus comprises several drying chambers (D).

20. An apparatus according to claim 16, wherein the capacity of the pressing means and pressing chamber (P) has been fitted to feed several drying chambers (D).

21. An apparatus according to claim 16,wherein the combination of treating elements (2) and wood or wood products (1) is moved from one chamber to another by means of an actuator.

22. An apparatus according to claim 16, wherein the drying chamber (D) contains at least two fans (10) disposed on opposite sides of the chamber and that an air flow is directed from the fan to the suction side of the fan placed on the opposite side of the chamber.

23. An apparatus according to claim 16, wherein the treating elements (2) can be locked with respect to each other by means of locking devices (6).

24. An apparatus for manufacturing a wood product board, especially a sandwich board, such as a plywood board, wherein the apparatus comprises a pressing chamber (P) containing pressing means, a drying chamber (D), and treating means (2) with spaces between them where a sandwich board blank consisting of fresh superimposed veneer sheets (1) and binding agent (G) can be arranged, which treating means can be locked in a pressing position, and that the combination of the treating means and the sandwich board blanks (1) in the spaces between them can be moved from the pressing chamber into the drying chamber and/or to a further processing stage.

25. An apparatus according to claim 24, wherein the pressing chamber and the drying chamber are the same space.

26. An apparatus according to claim 24, wherein the pressing chamber and the drying chamber are separate spaces.
